(19) United States
(12) Patent Application Publication
(10) Pub. No.: US 2010/0045230 A1
(43) Pub. Date: Feb. 25, 2010

(54) SOLAR POWER CONVERTING PACKAGE

(76) Inventors: Chieh-Cheng Chen, Taoyuan Hsien (TW); Han-Cheng Hsu, Taoyuan Hsien (TW); Ching-Liang Chiu, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/240,747

(22) Filed: Sep. 29, 2008

(30) Foreign Application Priority Data
Aug. 20, 2008 (TW) 097131665

(51) Int. Cl. H02J 7/00

(52) U.S. Cl. 320/101

(57) ABSTRACT

A solar power converting package includes a power storage unit, a power detecting unit coupled to the power storage unit, a power converting unit coupled to the power detecting unit, and a molding body enclosing the power storage unit, the power detecting unit and the power converting unit.

### CROSS REFERENCE TO RELATED APPLICATIONS

This Non-provisional application claims priority under 35 U.S.C. §119(a) on Patent Application No(s). 097131665 filed in Taiwan, Republic of China on Aug. 20, 2008, the entire contents of which are hereby incorporated by reference.

### BACKGROUND OF THE INVENTION

1. Field of Invention

The present invention relates to a package and, in particular, to a solar power converting package.

2. Related Art

The conventional DC charger is to convert the mains electricity into an acceptable voltage for the rechargeable battery or DC load. Thus, this kind of battery charger basically includes a set of rectification circuit, transformer and proper output circuit.

Since the power supply terminal of the conventional charger is connected to the mains electricity, the transformer is needed to transform the mains electricity to the proper voltage. The transformer is composed of an iron core and a winding material. When the primary winding set of the transformer is powered on, the magnetic flux generated by the coil can flow around the iron core. Because, the iron core is a conductive body, the induced electric potential is generated on the plane perpendicular to the magnetic lines. The electric potential forms a closed loop on the cross-section of the iron core and generates a current, which is called an Eddy current. The Eddy current can increase the consumption of the transformer and make the iron core of the transformer to generate heat, which will lead to the temperature rising of the transformer. The loss caused by the Eddy current is called the iron loss. In addition, a lot amount of copper wire is needed to manufacture the transformer. Since the copper wire has the inherent resistance, a certain amount of power loss will occur when the current flows through the copper wire. This kind of loss, which is called the copper loss, usually becomes the heat.

In addition, the involved elements and the design of the circuit must occupy a certain space for meeting the mains electricity so that the size of the charger is limited and can not be applied to the minimization.

### SUMMARY OF THE INVENTION

In view of the foregoing, an objective of the present invention is to provide a solar power converting package that can use the solar power and light energy as the input power source and can be applied to the small power output.

To achieve the above objective, the present invention discloses a solar power converting package including a power storage unit, a power detecting unit, a power converting unit and a molding body. The power detecting unit is connected to the power storage unit, and the power converting unit is connected to the power detecting unit. The molding body encloses the power storage unit, the power detecting unit and the power converting unit.

The power storage unit includes a capacitor, which has a capacitance lower than 10 μF.

The power detecting unit includes a detecting circuit, which includes a switching element. When the detecting circuit detects a voltage larger than a predetermined value, the switching element is turned on so as to transmit the electric power to the power converting unit. The switching element is a transistor, and the power converting unit includes an inductor.

The molding body is light-permeable or opaque, and the material thereof includes a polymer material. The molding body can be formed by molding according to a case so as to fill the molding material in the case to form the molding body. Alternatively, the molding body can also be formed by compression molding so as to compress the molding material to form the molding body.

In addition, the solar power converting package further includes a substrate, on which the power storage unit, the power detecting unit or the power converting unit is disposed. For example, the power storage unit, the power detecting unit and the power converting unit can be, respectively, disposed on opposite two sides of the substrate, on the same side of the substrate or through the substrate.

The substrate can be a single-layer circuit board or a multi-layer circuit board. The material of the substrate includes a resin, ceramic material, glass or metal.

In addition, the solar power converting package further includes a plurality of pins exposed out of the molding body. The pins are electrically connected with the circuit board to receive the electric power and are used to electrically connect with an external electronic device.

The solar power converting package of the present invention is a surface mount device (SMD), a dual in-line package (DIP), a ball-grid array (BGA) package or a pin-grid array (PGA) package.

The power storage unit is connected to a solar cell, such as an organic solar cell, a dye-sensitization solar cell or a monocrystalline silicon, multicrystalline silicon or amorphous silicon solar chip.

The power converting unit receives the electric power from the power detecting unit and converts the received electric power from a high voltage to a low voltage or from a low voltage to a high voltage so as to drive a load.

As mentioned above, the solar power converting package of the present invention has the molding body to enclose the elements for converting the solar power such as the power storage unit, the power detecting unit and the power converting unit. Thus, the size of the solar power converting package can be reduced, and the solar power converting package can be applied to the load with small power, such as an automatic flush apparatus for the urinal.

### BRIEF DESCRIPTION OF THE DRAWINGS

The present invention will become more fully understood from the detailed description given herein below and accompanying drawings which are given by way of illustration only, and thus are not limitative of the present invention, and wherein:

FIG. 1 is a block diagram of a solar power converting package according to an embodiment of the present invention;

FIGS. 2A and 2B are schematic illustrations showing different aspects of the solar power converting package according to the embodiment of the present invention; and

FIG. 3 is a sectional view of the solar power converting package according to the embodiment of the present invention.

### DETAILED DESCRIPTION OF THE INVENTION

The present invention will be apparent from the following detailed description, which proceeds with reference to the accompanying drawings, wherein the same references relate to the same elements.

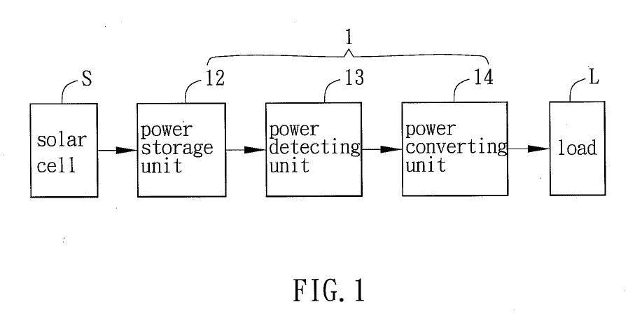

FIG. 1 is a block diagram of a solar power converting package 1 according to an embodiment of the present invention. The solar power converting package 1 includes a power storage unit 12, a power detecting unit 13, a power converting unit 14 and a molding body 15. The solar power converting package 1 is cooperated with a solar cell S. The type of the solar cell S of this embodiment is not limited and can be an organic or inorganic type. The inorganic-type solar cell can be a monocrystalline silicon, multicrystalline silicon or amorphous silicon solar chip. The organic-type solar cell can be an organic solar cell or a dye-sensitization solar cell.

The power storage unit 12 is connected to the solar cell S for storing the electric power generated by the solar cell S. The power storage unit 12 can include a capacitor for storing the power. In the embodiment, the capacitor has a capacitance lower than 10 μF.

The power detecting unit 13 is connected to the power storage unit 12 for detecting the stored electric power in the power storage unit 12. For example, the power detecting unit 13 can detect the voltage of the power storage unit 12. The power detecting unit 13 includes a detecting circuit for performing the detection. The detecting circuit includes a switching element. When the detecting circuit detects a voltage larger than a predetermined value, the switching element is turned on so as to transmit electric power to the power converting unit 14. Herein, the switching element can be a transistor.

The power converting unit 14 receives the electric power from the power detecting unit 13 and then converts the received electric power, for example, from a high voltage to a low voltage or from a low voltage to a high voltage so as to drive a load L. In the embodiment, the power converting unit 14 can include an inductor. In addition, the load L of the embodiment is a load with small power, such as an automatic flush apparatus of an indoor urinal.

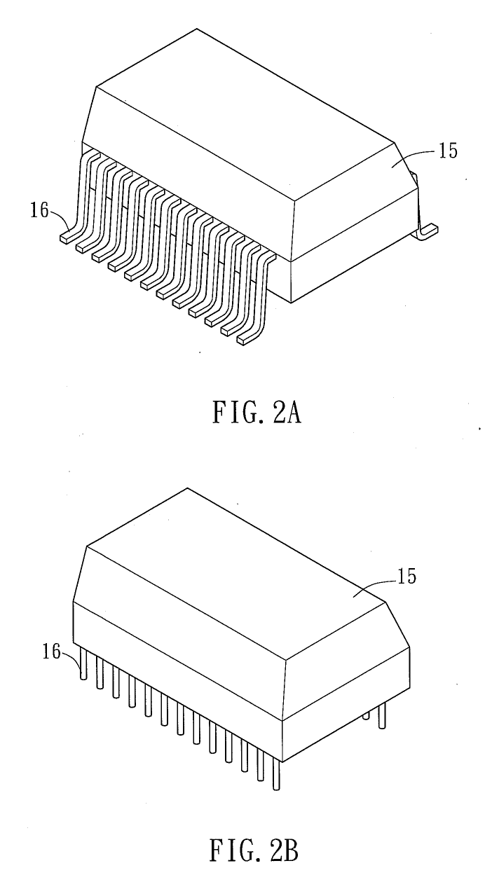

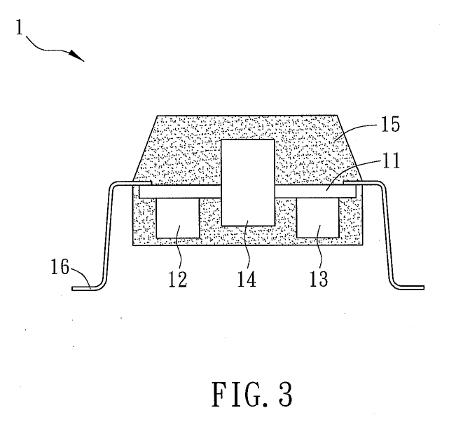

The molding body 15 encloses the power storage unit 12, the power detecting unit 13 and the power converting unit 14. As shown in FIGS. 2A, 2B and 3, the molding body 15 can be light-permeable or opaque, and the material of the molding body 15 can include a polymer material. The molding body 15 can be formed by molding according to a case. That is, the molding material is filled into the case to form the molding body 15. Alternatively, the molding body 15 can be formed by a compression molding technology. That is, the molding material is directly compressed to form the molding body 15.

The solar power converting package 1 further includes a plurality of pins 16 exposed out of the molding body 15. The solar power converting package 1 can be a SMD as shown in FIG. 2A, or a DIP as shown in FIG. 2B. Of course, the solar power converting package 1 can have different package aspects such as a BGA package or a PGA package depending on the application need.

With reference to FIG. 3, the solar power converting package 1 of the present invention can further include a substrate 11, such as a single-layer circuit board or a multi-layer circuit board. The pins 16 can be electrically connected to the circuit board so as to electrically connect with the solar cell S for receiving the electric power and to electrically connect with an external electronic device for driving the electronic device. The material of the substrate 11 can include a resin, ceramic material, glass or metal. In the embodiment, the power storage unit 12, the power detecting unit 13 and the power converting unit 14 can be, respectively, disposed on opposite two sides of the substrate 11, on the same side of the substrate 11 or through the substrate 11. In this case, the power storage unit 12 and the power detecting unit 13 are disposed on the same side of the substrate 11, and a part of the power converting unit 14, such as the inductor, is disposed through the substrate 11. Since the power converting unit 14 is disposed through the substrate 11, the total size of the package 1 can be reduced.

In summary, the solar power converting package of the present invention uses the solar power and light energy as the input power source, so that it can be applied to the application of small power. The output terminal of the solar power converting package can connect to proper load, which can be chosen depending on the various applications, such as an automatic flush apparatus for the urinal.

The solar power converting package of the present invention has the molding body to enclose the elements for converting the solar power such as the power storage unit, the power detecting unit and the power converting unit. Thus, the size of the solar power converting package can be reduced so as to avoid the space waste for the conventional transformer and prevent the problems such as overheating and large power consumption. In addition, the applications of the solar power converting package of the present invention are very wide because the output of the solar power converting package can be adjusted according to different levels of power source so as to fit the input for various applications. When utilizing the solar power as the input power source cooperating with the proper solar cell, the electric power can be outputted in any place with light. Thus, the solar power converting package of the present invention is very convenient.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A power converting package comprising:
a power storage unit;
a power detecting unit coupled to the power storage unit;
a power converting unit coupled to the power detecting unit; and
a molding body enclosing the power storage unit, the power detecting unit and the power converting unit.

2. The solar power converting package according to claim 1, wherein the power storage unit comprises a capacitor.

3. The solar power converting package according to claim 2, wherein the capacitor has a capacitance lower than 10 μF.

4. The solar power converting package according to claim 1, wherein the power detecting unit comprises a detecting circuit.

5. The solar power converting package according to claim 4, wherein the detecting circuit comprises a switching element, and when the detecting circuit detects a voltage larger than a predetermined value, the switching element is turned on so as to transmit electric power to the power converting unit.

6. The solar power converting package according to claim 5, wherein the switching element is a transistor.

7. The solar power converting package according to claim 1, wherein the power converting unit comprises an inductor.

8. The solar power converting package according to claim 1, wherein the molding body is light-permeable or opaque.

9. The solar power converting package according to claim 1, wherein a material of the molding body comprises a polymer material.

10. The solar power converting package according to claim 9, wherein the molding body is formed by molding using a case as a mold, or formed by compression molding.

11. The solar power converting package according to claim 1, further comprising a substrate, wherein the power storage unit, the power detecting unit or the power converting unit is disposed on the substrate.

12. The solar power converting package according to claim 11, wherein the substrate is a single-layer circuit board or multi-layer circuit board, and a material of the substrate comprises a resin, ceramic material, glass or metal.

13. The solar power converting package according to claim 11, wherein the power storage unit, the power detecting unit and the power converting unit are respectively disposed on opposite two sides of the substrate, on the same side of the substrate or through the substrate.

14. The solar power converting package according to claim 1, further comprising a plurality of pins exposed out of the molding body.

15. The solar power converting package according to claim 14, wherein the pins are electrically connected with a circuit board to receive electric power and are electrically connect with an external electronic device.

16. The solar power converting package according to claim 1, being a surface-mount device, a dual in-line package, a ball-grid array package or a pin-grid array package.

17. The solar power converting package according to claim 1, wherein the power storage unit is connected to a solar cell.

18. The solar power converting package according to claim 17, wherein the solar cell is a monocrystalline silicon, multicrystalline silicon or amorphous silicon solar chip.

19. The solar power converting package according to claim 17, wherein the solar cell is an organic solar cell or a dye-sensitization solar cell.

20. The solar power converting package according to claim 1, wherein the power converting unit receives electric power from the power detecting unit and converts the received electric power from a high voltage to a low voltage or from a low voltage to a high voltage so as to drive a load.
